(19) United States
(12) Patent Application Publication
(10) Pub. No.: US 2006/0236025 A1
(43) Pub. Date: Oct. 19, 2006

(54) Method and apparatus to control number of erasures of nonvolatile memory

(75) Inventor: Avigdor Eldar, Jerusalem (IL)

Correspondence Address: PEARL COHEN ZEDEK LATZER, LLP, 1500 BROADWAY, 12TH FLOOR, NEW YORK, NY, 10036, US

(73) Assignee: INTEL CORPORATION

(21) Appl. No.: 11/107,971

(22) Filed: Apr. 18, 2005

(51) Int. Cl. G06F 12/00

(52) U.S. Cl. 711/103

(57) ABSTRACT

Briefly, a method an apparatus and a computational platform to control a number of erasures of a block and/or a sector of nonvolatile memory by allowing a predetermined number of erasures of the sector and/or the block of the nonvolatile memory within a predetermined time interval.

### BACKGROUND OF THE INVENTION

An organization private network such as, for example, an Intranet, may include various types of computational platforms, for example, desktop computers, laptop computers and the like. The computational platforms may be remotely maintained and managed by the organization network and support teams, which may also be referred to as Information Technology (IT) teams. The computational platforms may include and/or may be coupled to a management system which may enable a remote IT technician to access a managed system of a computational platform and to perform maintenance and/or management operations such as, for example, heal computing assets, discover computing assets, remove or install computing assets, remotely restart the computational platform or managed system, and the like.

The management system may include a nonvolatile memory, for example, a Flash memory to store data that may be used by the management system. The nonvolatile memory may include a plurality of blocks and the blocks may include sectors. Read/write operations may be preformed to write and read data onto/from the blocks/sectors of the nonvolatile memory. The write operation may be performed by first erasing a block and/or a sector and then writing onto the erased block/sector. In some nonvolatile memory devices the number of write operations are limited Once the block and/or sector exceeds the limit on the number of write operations, the block/sector may become unusable.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic block diagram of a computational platform according to an exemplary embodiment of the present invention;

FIG. 2 is a schematic block diagram of a portion of a management system according to exemplary embodiments of the invention;

FIG. 3 is a schematic flowchart of a method to manage write operations of a nonvolatile memory according to exemplary embodiments of the present invention;

FIG. 4 is a schematic flowchart of a method of protecting erasure of a sector and/or a block of a nonvolatile memory according to exemplary embodiments of the present invention; and

FIG. 5 is a schematic flowchart of another method of protecting erasure of a sector and/or a block of a nonvolatile memory according to exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like. For example, “plurality of mobile stations” describes two or more mobile stations.

It should be understood that the present invention may be used in a variety of applications. Although the present invention is not limited in this respect, the circuits and techniques disclosed herein may be used in many apparatuses such as platforms of computer systems.

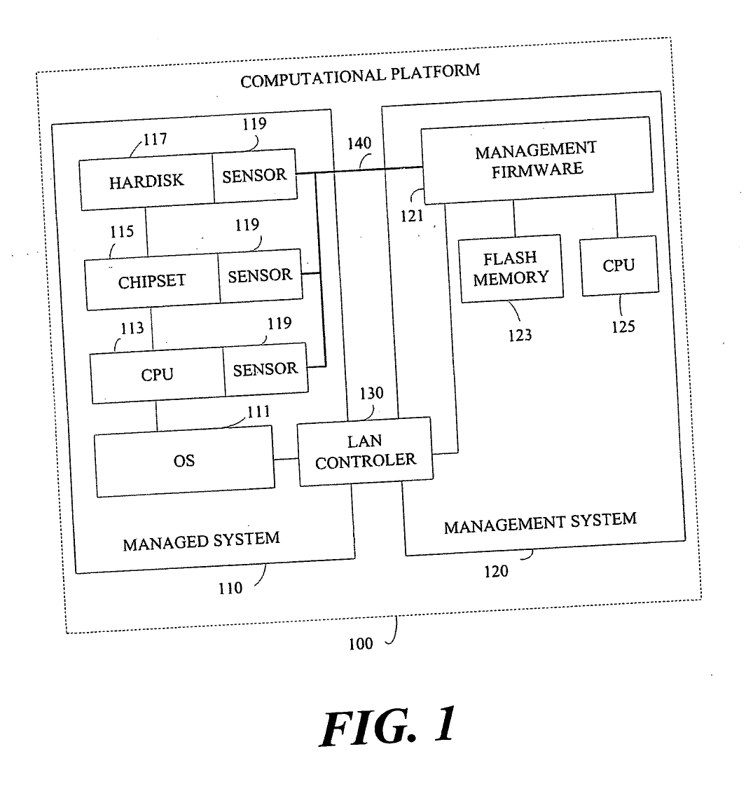

Turning to FIG. 1, a schematic block diagram of a computational platform 100 according to an exemplary embodiment of the present invention is shown. Although the scope of the present invention is not limited in this respect, computational platform 100 may include a managed system 110, a management system 120 and a local area network (LAN) controller 130 that may be used to establish a connection between managed system 110 and management system 120. In embodiments of the invention, managed system 110 may include a desktop computer, a laptop computer, a hand held computer, a terminal and the like. According to embodiments of the present invention, management system 120 may be used to mange resources of managed system 110, if desired.

According to an exemplary embodiment of the invention, managed system 110 may include a central processing unit (CPJ) 113, a chipset 115 and a hard disk 117. Managed system 110 may further include an operating system (OS) 111, which may be stored on hard disk 117 or other memory, and may be executed by and/or in communication with CPU 113 and/or chipset 115. One or more sensors 119 may be coupled to CPU 113, chipset 115 and hard disk 117 to sense status of components of managed system 110 and to report the status of the components, e.g. of CPU 113, chipset 115 and hard disk 117, to management system 120, if desired.

According to an exemplary embodiment of the invention, management system 120 may include: management firmware 121 to receive status signals over a bus 140 from sensors 119; a nonvolatile memory, for example a flash memory 123 to store, for example, management applications, repair applications, data and the like; and a CPU 125 to control operations and components of management system 120, if desired.

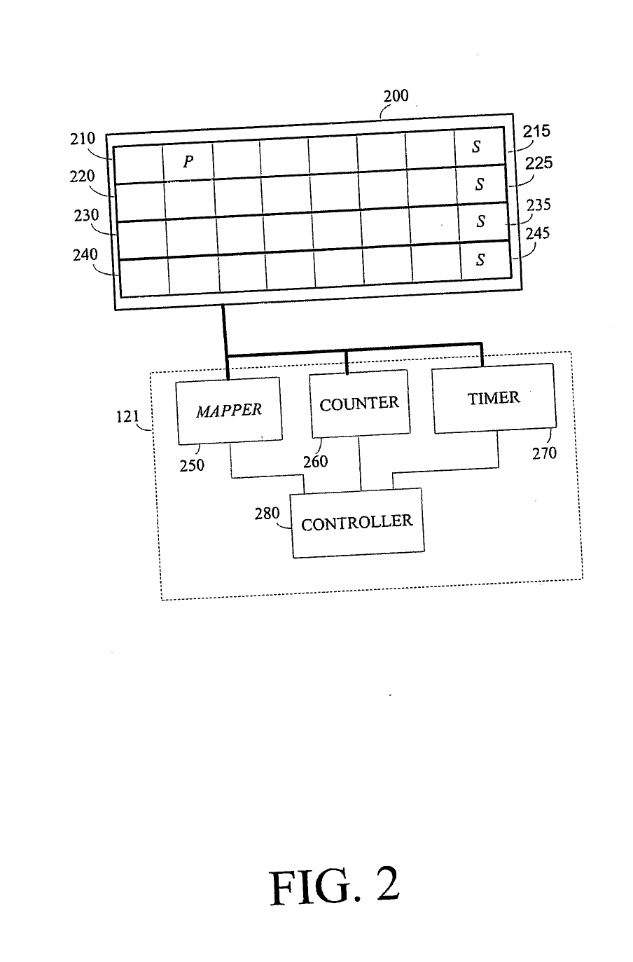

Turning to FIG. 2, a block diagram of a portion of management system 120 according to exemplary embodiments of the present invention is shown. Although the scope of the present invention is not limited in this respect, according to exemplary embodiment of the invention, the portion of system 120 shown in FIG. 2 includes a nonvolatile memory 200 that may include, for example, any type of Flash memory, Erasable Programmable Read-Only Memory (EPROM), or the like, and a portion of management firmware 121. For example, management firmware 121 may include a mapper 250, a counter 260 and a timer 270 and a controller 280. According to exemplary embodiment of the invention, nonvolatile memory 200 may include blocks 210, 220, 230, 240, and blocks 210, 220, 230, 240 may include physical sectors, for example P sector, and scratch sectors, for example S sectors 215, 225, 235, 245.

According to some embodiments of the invention, the term “block” may correspond to a physical portion of the nonvolatile memory and the term “sector” may correspond to logical data located within a “block”, if desired. In addition, the term “scratch sector” may correspond to a temporary logical data located within a block.

According to some exemplary embodiments of the present invention, a write operation may be preformed on sector P of block 210. For example, the write operation may start by randomly selecting one of scratch sectors 225 or 235, followed by erasing the selected scratch sector (e.g. scratch sector 235), and may end by writing the data to the selected scratch sector (e.g. scratch sector 235) and mapping a target address of the data to the selected scratch sector and the address of the scratch sector e.g., the address of sector 235, to the target address e.g., the address of sector P of block 210, if desired. In some embodiments of the invention, a mapper 250 may perform the writing and mapping operations, if desired.

According to some other embodiments of the invention, controller 280 may include counter 260, timer 270 and mapper 250. According to this exemplary embodiment of the invention, controller 280 may control counter 260, timer 270 and mapper 250. Counter 260 and timer 270 may be used by an algorithm and/or method of controlling a number of writing operations to a scratch sector, e.g., sectors 224 and/or 226. According to this exemplary method counter 260 may count a number of writes to nonvolatile memory 200 and controller 280 based on timer 270 may periodically vary a number of desirable writes by a predetermined number. For example, for count-up counter, controller 280 may decrease the number of desirable writes by a predetermined number and for count-down counter, controller 280 may increase the number of desirable writes by a predetermined number, although the scope of the present invention is not limited in this respect. In some embodiments of the present invention, for example the number of desirable writes may be lower and/or equal to the number of allowed and/or maximum number of writes that a manufacturer of the nonvolatile memory defines in a specification of the nonvolatile memory.

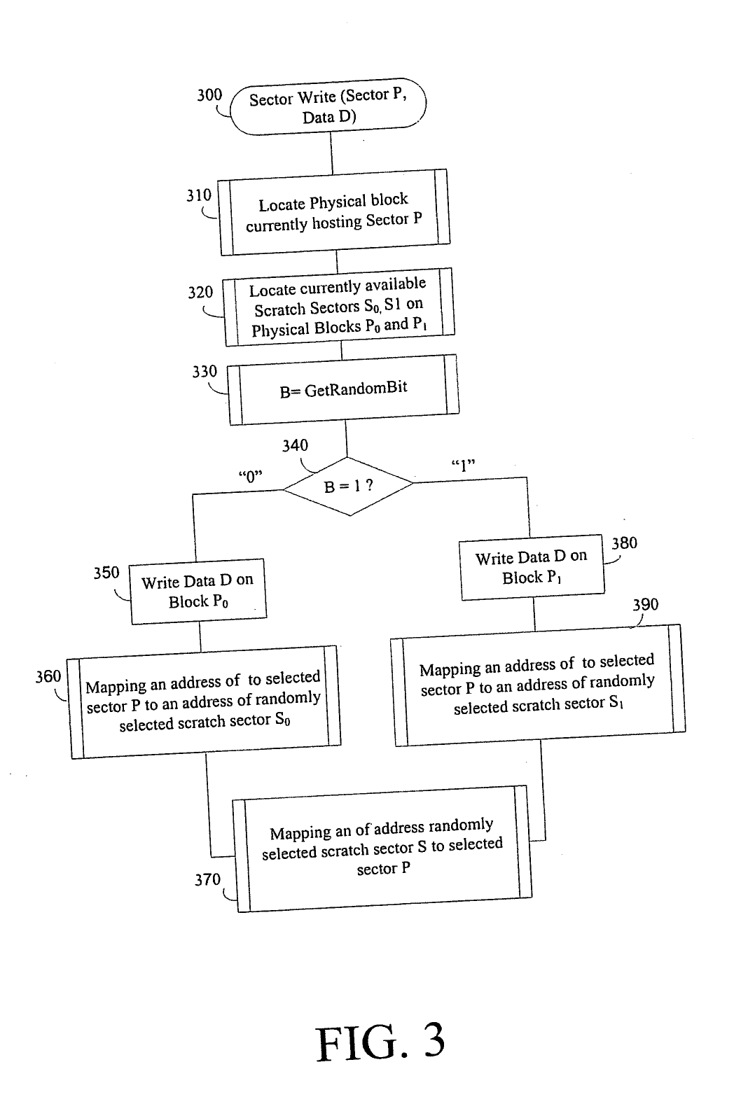

Turning to FIG. 3, a schematic flow diagram of a method of writing data to a nonvolatile memory according to exemplary embodiments of the present invention is shown. Although the scope of the present invention is not limited to this respect, according to some exemplary embodiments of the invention, a controller, for example, management firmware 121 and/or CPU 125, may control a number of erasures of the nonvolatile memory by allowing a predetermined number of erasures of the nonvolatile memory within a predetermined time interval. According to this exemplary method, the controller may attempt to write to sector (P) data (D) (text block 300). The controller may locate a physical block that hosts sector P, e.g., block 210 of nonvolatile memory 200, (text block 310).

According to this exemplary method, the controller may randomly locate two or more scratch sectors S on two or more physical blocks, for example, scratch sectors 225, 235 of physical blocks 220, 230, respectively (text block 320). The controller may randomly select a scratch sector by a value of a random bit B (text block 330). For example, for a value of “1” of random bit B the selected scratch sector may be scratch sector 225, and for a value of “0” of random bit B the selected scratch sector may be scratch sector 225

Although the scope of the present invention is not limited in this respect, the controller may write data onto the selected scratch sector (text blocks 350, 380) and may map an address of selected sector P onto the address of randomly selected scratch sector S (text blocks 360, 390). Furthermore, the controller may map an address of randomly selected scratch sector S onto selected sector P (block 370). It should be understood that according to other embodiments of the invention, a scratch sector may be selected from more then two scratch sectors, the scratch sectors may be on the same block and/or on different blocks and the selection may be done by two or more random bits.

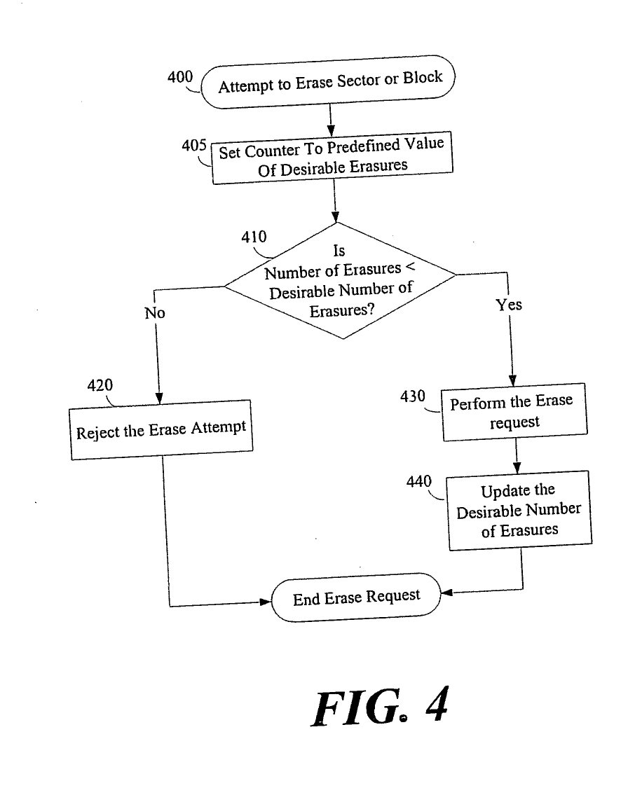

Turning to FIG. 4, a flowchart of method of protecting an erasure of a sector and/or a block of a nonvolatile memory according to exemplary embodiments of tie present invention is shown Although the scope of the present invention is not limited to this respect, a counter, e.g., counter 260, may be initialized to count a number of erasures of a sector and/or block of the nonvolatile memory and the method may determine when a desirable number of erasures is reached. For example, the counter may be pre-set to count-down from a desired number of erasures. According to this exemplary method, controller 280 may periodically vary a desirable number of erasures by a predetermined number. For example, for count-up counter, controller 280 may decrease the number of desirable erasures by a predetermined number and for count-down counter, controller 280 may increase the number of desirable erases by a predetermined number, although the scope of the present invention is not limited in this respect.

According to some exemplary embodiments of the invention, an attempt of erasing a sector of a nonvolatile memory, e.g., Flash Memory 123, may be received (text block 400). According to some embodiments of the invention a counter, for example, counter 260, may count the number of erasures of the sector and/or a block of the nonvolatile memory. For example, a counter for counting the number of erasures may be set for each block and/or sector of the nonvolatile memory. The counter may be an up-counter or a down-counter, if desired.

According to this method, a check may be performed to determine whether the counter exceeds a desirable number of erasures (text block 410). If the number of erasure attempts exceeds the desirable number of erasures then the method may reject the erasure attempt (text block 420). If the desirable number of erasures has not been reached, the method may allow the erasure attempt (text block 430) and the counter may update the number of erasures. The counter may be referred to herein as “credit counter” and the desirable number of erasures may be referred as “credit”.

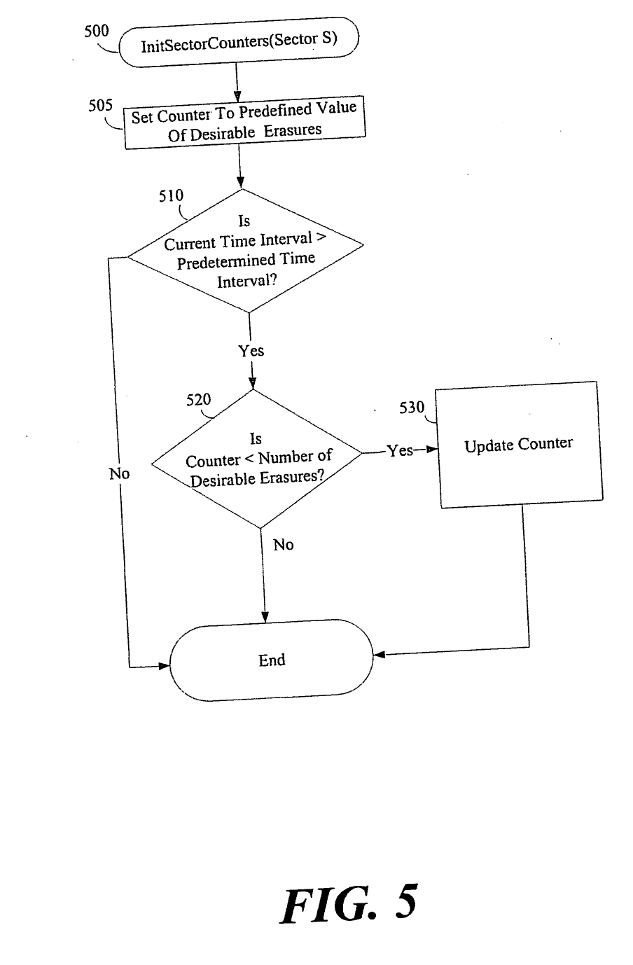

Turning to FIG. 5, a flowchart of another method of protecting an erasure of a sector and/or a block of a nonvolatile memory according to exemplary embodiments of the present invention is shown. Although the scope of the present invention is not limited to this respect, a counter e.g., counter 260, may be initialized to count a number of erasures and the method may determine when an allowed number of erasures is reached. For example, the counter may be pre-set to count-down from a desirable number of erasures or the counter may be pre-set to count-up to the desirable number of erasures. According to some exemplary embodiments of the invention, an attempt of erasing a sector of a nonvolatile memory, e.g., Flash Memory 123, may be received. Additionally, according to some embodiments of the invention, a timer, for example, timer 270, may be set to measure time intervals and the counter, for example, counter 260, may count the number of erasures of the sector and/or a block of the nonvolatile memory during a predefined time interval.

According to some embodiments of the invention, the timer may be set for each sector and/or block of the nonvolatile memory (text block 500). If the interval timed by the timer exceeds a predetermined time interval (text block 510) and the counter does not exceed the desirable number of erasures (text block 520), then the desirable number of erasures may be updated (text block 530). For example, the counter may be an up count counter and the desirable number of erasures may be decrease. In another exemplary embodiment the counter may be a count down counter and the desirable number of erasures may be increased.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. An apparatus comprising:
a controller to control a number of erasures of a nonvolatile memory by allowing a predetermined number of erasures of the nonvolatile memory within a predetermined time interval.

2. The apparatus of claim 1, comprising:
a counter to count a number of erasures of a sector of the nonvolatile memory.

3. The apparatus of claim 1, comprising:
a counter to count a number of erasures of a block of the nonvolatile memory.

4. The apparatus of claim 1, comprising:
a timer to periodically measure the predetermined time interval and wherein the controller is able to vary a number of erasures that where counted by the counter by a predetermined number based on a number of erasures that where counted by the counter during the predetermined time interval.

5. The apparatus of claim 2, wherein the controller is able to reject an attempt to erase the nonvolatile memory based on a count value of the counter.

6. The apparatus of claim 2, wherein the controller is able to set the desirable number of erasures of the nonvolatile memory and the counter is able to count according to the desirable number.

7. The apparatus of claim 1, wherein the nonvolatile memory comprises:
first and second blocks having first and second scratch sectors, respectively, wherein either the first and second scratch sector is randomly selected to be written with data which is addressed to be written on a physical sector of a physical block of the nonvolatile memory

8. A method comprising:
controlling a number of erasures of a nonvolatile memory by allowing a predetermined number of erasures of the nonvolatile memory within a predetermined time interval.

9. The method of claim 8, comprising:
counting the number of erasures of a block of the nonvolatile memory.

10. The method of claim 8, comprising:
counting the number of erasures of a sector of the nonvolatile memory.

11. The method of claim 8, comprising:
periodically varying a number of counted erasures by a predetermined number based on the number of erasures that where counted during a predetermined time interval.

12. The method of claim 8, comprising:
rejecting an attempt to erase the nonvolatile memory based on a desirable number of erasures of the nonvolatile memory.

13. The method of claim 8, comprising:
selecting a sector of a block to store data;
randomly selecting a scratch sector of first and second scratch sector of the nonvolatile memory to be written with the data; and
mapping an address of the scratch sector to reflect an address of the sector.

14. A computational platform comprising:
a management system that include a controller to control a number of erasures of a nonvolatile memory by allowing a predetermined number of erasures of the nonvolatile memory within a predetermined time interval.

15. The computational platform of claim 14, wherein the management system comprises:
a management firmware that includes a counter to count a number of erasures of a sector of the nonvolatile memory.

16. The computational platform of claim 14, wherein the management system comprises:
a management firmware that includes a counter to count a number of erasures of a block of the nonvolatile memory.

17. The computational platform of claim 14, wherein the management system comprises:
a management firmware that includes a timer to periodically measure the predetermined time interval and wherein the controller is able to vary a number of erasures that where counted by the counter by a predetermined number based on a number of erasures that where counted by the counter during the predetermined time interval.

18. The computational platform of claim 15, wherein the controller is able to reject an attempt to erase the nonvolatile memory based on a count value of the counter.

19. The computational platform of claim 15, wherein the controller is able to set to set the desirable number of erasures of the nonvolatile memory and the counter is able to count according to the desirable number.

20. The computational platform of claim 14, wherein the nonvolatile memory comprises:
first and second blocks having first and second scratch sectors, respectively, wherein either the first and second scratch sector is randomly selected to be written with data which is addressed to be written on a physical sector of a physical block of the nonvolatile memory.

21. An article comprising: a storage medium, having stored thereon instructions, that when executed, result in:
controlling a number of erasures of a nonvolatile memory by allowing a predetermined number of erasures of the nonvolatile memory within a predetermined time interval.

22. The article of claim 21, wherein the instructions when executed result in:
counting the number of erasures of a block of the nonvolatile memory.

23. The article of claim 21, wherein the instructions when executed result in:
counting the number of erasures of a sector of the nonvolatile memory.

24. The article of claim 21, wherein the instructions when executed result in:
periodically varying a number of counted erasures by a predetermined number based on the number of erasures that where counted during a predetermined time interval.

25. The article of claim 21, wherein the instructions when executed result in:
rejecting an attempt to erase the nonvolatile memory based on to an desirable number of erasures of the nonvolatile memory.

26. The article of claim 21, wherein the instructions when executed result in:
selecting a sector of a block to store data;
randomly selecting a scratch sector of first and second scratch sector of the nonvolatile memory to be written with the data; and
mapping an address of the scratch sector to reflect an address of the sector.
